(19) United States
(12) Patent Application Publication
(10) Pub. No.: US 2005/0060243 A1
(43) Pub. Date: Mar. 17, 2005

(54) Method for managing tools in a power plant service environment

(75) Inventors: Jeff P. Whetman, Orlando, FL (US); David L. Wilson, Duluth, GA (US); Joseph R. Schulties, Gibsonia, PA (US); Douglas O. Hoffman, Seabrook, TX (US); Aaron A. Danneman, Roswell, GA (US); Jacqueline M. Cavicchio, Jeannette, PA (US); Diane Michelle Murray, Shoreacres, TX (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/661,682

(22) Filed: Sep. 12, 2003

(51) Int. Cl. G06F 17/60

(52) U.S. Cl. 705/28

(57) ABSTRACT

A method in a data processing system of tracking tools in a power plant service environment is disclosed where a plurality of power plant facilities (14) are interconnected in a Web-based environment (22) over a communications medium (10) with a tool depot 16 and wherein the tool depot (16) houses a tool inventory (17) used for providing a plurality of service activities to the plurality of power plant facilities (14). The method may include providing (30) a database (20) containing information associated with respective tools in the tool inventory (17) and including in the database (20) information uniquely associated with at least a first tool in the tool inventory (17). The first tool may be assigned (42) to a person at a power plant facility (14) and data may be recorded at the power plant facility that associates the person with the first tool. The method may also include providing (30) a database (20) containing information describing the inventory of tools and providing access to the database to respective end users at each of the multiple power plants via a communications medium. An order for a set of tools may be communicated over the communications medium (36) to a tool depot (16) and a shipping document may then be populated (40) with information relating to shipping the set of tools from the tool depot (16) to a power plant (14). One aspect allows for accessing the database (20) from the power plant (14) so that an end user at the power plant may search the database via in interactive Web page for selecting at least one tool (36) for inclusion in the set of tools. The at least one tool may be selected from the Web page to create the tool order.

### FIELD OF THE INVENTION

This invention relates in general to methods for managing inventories and more particularly to a method for centrally controlling and tracking discrete inventories of tools.

### BACKGROUND OF THE INVENTION

Many industrial facilities such as thermal power plants are constructed of various complex systems requiring services such as inspection, maintenance, upgrade and repair of the systems and/or subsystems. Such services frequently require diverse combinations of tools as a function of the type and scope of services to be performed at any given time. It is common in industry that several such facilities or remote sites will be operated by the same operator. The operator may perform services on the facility or have an independent supplier provide the services. In either case, a tool depot or plurality of regional tool depots may be used to house distinct inventories of tools for use in performing the services at the remote sites. Each tool depot may house hundreds of tools or more that have to be inventoried and managed in performance of the services. Some tools are very sophisticated and expensive, so a limited number of such tools may be used to serve a large number of remote sites.

Known methodologies for submitting requests for tools and managing the distribution and return of those tools employ a relatively high number of person-to-person and/or person-to-machine events. For example, a tool order may be placed to a tool depot by email, fax, telephone or hand delivery of a piece of paper. The order may then be manually input into a database and transmitted to a warehouse or tool depot where the tool order will be manually built into a tool kit from parts stored in a system of bins. The tool kit may then be shipped to the remote site where the tools may be manually inventoried again to determine loss, theft or damage during shipment. After the services are performed at the remote job site, the tool kit may be shipped back to the tool depot where the tools may be inventoried once again such as by manually assessing each tool to determine its condition. Data indicative of the inventoried tools may then be manually input into the database and a bill may be generated reflecting the cost of the tool ordering transaction and any fees associated with the use of those tools such as flat rate fees, rental fees, etc. Such a methodology is prone to human error, is inefficient and does not easily allow for personal accountability of tool loss, damage and/or theft, for example. Such methodology frequently do not allow for an accurate accounting of individual tools during each phase of a tool order life cycle. For example, it is known in the power generation industry that tools may be lost during use in a component of a power plant such as a gas turbine. Such an event may lead to catastrophic financial, equipment and/or personnel loss that could have been avoided if the tool had been accurately tracked during its use.

Further, when a plurality of tool depots serve a plurality of geographically remote job sites, the methodology described above becomes increasingly subject to human error and burdensome from an administrative perspective. This is especially true when each tool depot employs a distinct methodology for its respective inventory management.

### SUMMARY OF THE INVENTION

It has been found advantageous to provide a method for ordering tools and for controlling and tracking the distribution and return of those tools that is automated, unified across a plurality of tool depots and remote sites, and that allows for personal accountability of tool use and return. It is further advantageous to adapt this methodology for use over a communications network and to reduce the number of person-to-person and/or person-to-machine events necessary to execute the methodology.

One exemplary embodiment of the present invention provides for a method in a data processing system of tracking tools in a power plant service environment where a plurality of power plant facilities are interconnected in a Web-based environment over a communications medium with a tool depot and wherein the tool depot houses a tool inventory used for providing a plurality of service activities to the plurality of power plant facilities. The method may include providing a database containing information associated with respective tools in the tool inventory and including in the database information uniquely associated with at least a first tool in the tool inventory. The first tool may be assigned to a person at a power plant facility and data may be recorded at the power plant facility that associates the person with the first tool. Assigning the first tool to a specific person at the power plant facility is advantageous in that it allows for a more accurate tracking of that tool while in use.

Another exemplary embodiment of the present invention provides for a method of managing and tracking tools used in a power plant service environment wherein multiple power plants require services that necessitate the multiple utilization of an inventory of the tools stored in at least one tool depot The method may include providing a database containing information describing the inventory of tools and providing access to the database to respective end users at each of the multiple power plants via a communications medium. An order for a set of tools may be communicated over the communications medium to a tool depot and a shipping document may then be populated with information relating to shipping the set of tools from the tool depot to a power plant. One aspect allows for accessing the database from the power plant so that an end user at the power plant may search the database via in interactive Web page for selecting at least one tool for inclusion in the set of tools. The at least one tool may be selected from the Web page to create the tool order.

Another exemplary embodiment of the present invention provides for a method of managing tools in a field service environment wherein a plurality of service activities are performed at a plurality of job sites with a plurality of tools. The method may include using a first tool of the plurality of tools to perform a plurality of sequential service activities and storing in a database information uniquely associating the first tool with the performance of the sequential service activities. The database may then be accessed to reverse trace information regarding the use of the first tool for performing the sequential service activities.

### BRIEF DESCRIPTION OF THE DRAWINGS

These and other advantages of the invention will be more apparent from the following description in view of the drawings that show:

FIG. 1 is a schematic diagram of a communications scheme that may be used to implement aspects of the present invention;

FIG. 2A is a portion of a flow diagram of an exemplary method of managing an inventory of tools housed at one or more tool depots and used to provide services to one or more remote job facilities; and

FIG. 2B is a continuation of the flow diagram of FIG. 2A.

### DETAILED DESCRIPTION OF THE INVENTION

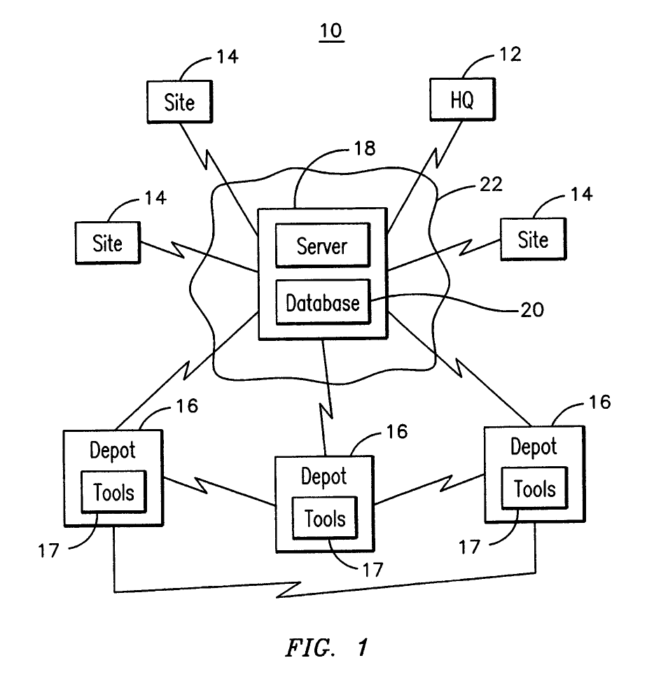

FIG. 1 illustrates an exemplary communications medium 10 over which exemplary methods of the present invention may be implemented. One exemplary embodiment may include interconnectivity for the transmission and exchange of electronic data among a host or management center 12, a plurality of remote sites 14, a plurality of tool depots 16 and at least one server 18 operable with a database 20. Conventional hardware, software and communications protocols may be used as will be recognized by those skilled in the art. For example, server 18 may be an IBM WebSphere application server and database 20 may be an appropriately configured Oracle database that may reside at one location or database 20 may be configured as a plurality of discrete databases residing at a plurality of locations, for example. Each tool depot 16 may house an independent inventory of tools 17 that may be used to provide inspection, testing, maintenance, upgrade and/or repair services, for example, to one or more of the remote sites 14. The inventories of tools 17 may also be used for other purposes such as equipment installation and system and/or subsystem diagnostics, for example, and may include consumables and mobile tool trailers associated with such activities. One aspect allows for items that are designed and/or fabricated at a remote site 14, such as by using a mobile machine shop, to be added to a respective one or more of the inventories of tools 17. It will be recognized by those skilled in the art that aspects of the present invention may be used for controlling and tracking objects between various points of origin and points of destination other than the items in the inventories of tools 17.

Exemplary embodiments of methods of the present invention may be implemented over a Web-based communications medium 22 allowing for interconnectivity over the Internet and/or an intranet, for example, among the host or management center 12, the plurality of remote sites 14, the plurality of tool depots 16, the server 18 and the database 20. The host or management center 12, the plurality of remote sites 14 and the plurality of tool depots 16 may include conventional servers, software and databases (not shown) such as Oracle servers and databases, etc. It will also be recognized by those skilled in the art that wireless communication systems, such as satellite communications for example, may be employed to implement aspects of the present invention. One aspect allows for a portable satellite communications device to be used for linking the system modules described herein with appropriate satellites and appropriate ground facilities.

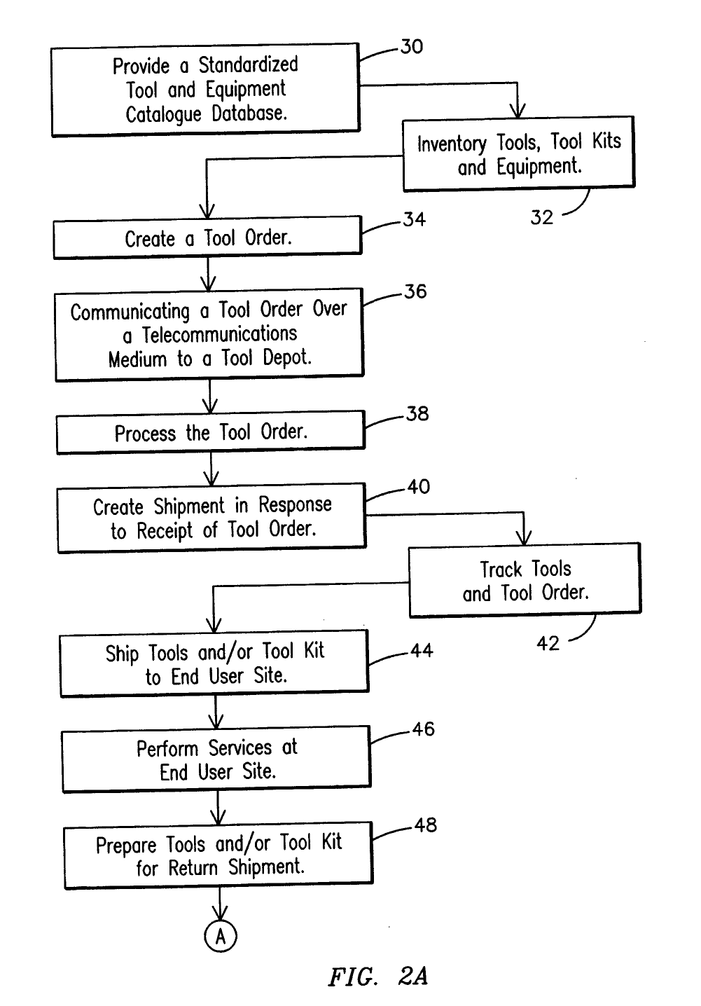

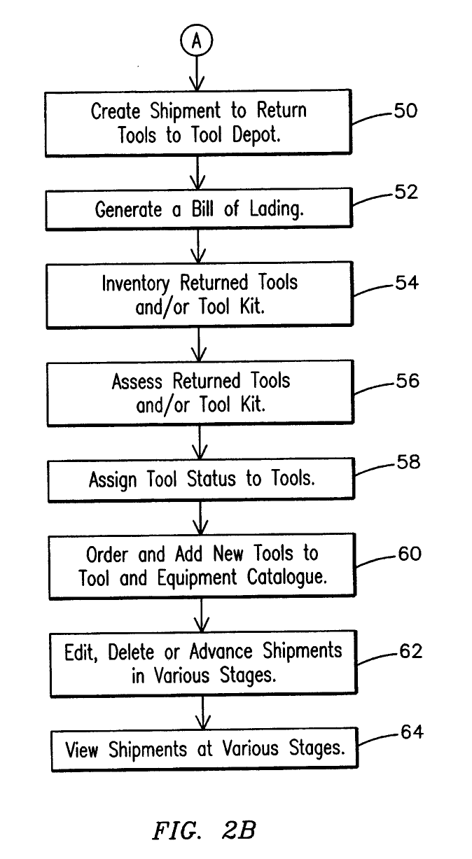

A processing and control module or processing module (not shown), which may be an application program running on server 18, may be provided for controlling and executing computer-executable code to implement various aspects of the present invention as will be recognized by those skilled in the art. The control module may include a tool catalogue module for creating and controlling a standardized tool and equipment catalogue database (tool catalogue) and for controlling each tool depot's 16 respective tool inventory database (not shown), as necessary. FIG. 2 illustrates an exemplary flow diagram that may include the step 30 of providing the tool catalogue, which may be stored in database 20, for example. Database 20 may also include information specifically identifying and/or describing each of the tool depots 16, remote sites 14 and management center 12 for implementing aspects of the present invention. Alternate embodiments allow for the tool catalogue to be located at any remote location provided it may be accessed over the communications medium 10 by at least one of, or a combination of, the host or management center 12, the plurality of remote sites 14 and the plurality of tool depots 16. The tool catalogue allows for standardizing the nomenclature used for identifying the tools, pre-built tool kits, customized tool kits and/or equipment (items) contained in the tool catalogue across each of the plurality of tool depots 16. Such standardization is advantageous in that it ensures that common items found in more than one of the tool depot's 16 respective inventory of tools 17 have the same name, for example, so that when a project manager or engineer places an order for an item there will be no confusion as to the identification of that item.

One aspect allows for the tool catalogue standardization methodology to include a specific format that provides a general-to-detailed description of a particular item in the catalogue. For example, the specific format may be expressed as a string list such as: noun, modifier, modifier and modifier. The tool catalogue may be segmented to define a group of categories for dividing the different items therein such as tools and equipment. The categories may also include, for example: kit items, expendable items and non-catalogued items. The tool catalogue may also include a plurality of fields that provide detailed information about each item in the catalogue. The fields may include, for example: country of origin, bin locations, durable vs. expendable, SKU (Stock Keeping Unit) and a vendor table from which the item may be purchased. Exemplary fields relating specifically to tools and tool kits may include: tool description, tool kit location and heat number for weld wire. Alternate embodiments may include other descriptive fields as a function of the type of items being controlled and tracked, for example.

One aspect allows for the tool catalogue module to be configured so that end users, such as a tool depot 16 administrator, may execute functional tasks relating to the tool catalogue such as, for example:
Searching the Tool Catalogue—items may be searched for by keyword(s) and/or SKU, for example
Creating a New Tool Record
Creating a Tool Kit Record
Editing/Updating a Tool or Tool Kit Record
Printing the Tool Catalogue
Offline Downloading for Local Tool Catalogue
   It should be noted that the term “tool” may be used herein as a general reference to any item contained in the tool catalogue, as well as to its ordinary meaning. The tool catalogue module may allow for the respective inventory of tools 17 databases of each tool depot 16 to be searched individually. If a tool catalogue search is being performed within an order module (more fully described below) then an Add to Tool List option may appear in the end user's Web page so that the end user may select an item from the list and add it to a tool order. A successful search will display an item or items in the tool catalogue, which may be further detailed by a pop-up window of detailed information pertaining to the searched item. The tool catalogue module may also allow for an end user to create, edit and update tool and tool kit records. For example, an end user may create a new record via text boxes in a Web page to enter item-specific information into database 20. Such information may include, for example:
Location by Tool Depot
Tool Category
Tool Type
Tool Name
Unit of Measure
Additional descriptive information such as Weight, Dimensions, Serialized Tool Information, Weld Wire, Heat Number for Weld Wire, Old Catalogue Number and Information for Forward and Reverse Traceability
Manufacturer Name, Part Number, Model Number and Country of Origin
Tool Replacement Cost
Material Safety Data Sheet (MSDS) requirement, Schedule B Number, Harmonized Tariff Code, Export Control Classification Number and Hazardous Material information
Minimum Level and Maximum Level quantities for re-order level
Tool Status
Comments
   The end user may use the tool catalogue module to edit or update this information. On confirming and submitting a new item to the tool catalogue the end user may use an inventory module (more fully described below) to generate a new unique identifier for the item such as a serial number. Similarly, a new tool kit (Kit) record may be created by using an administration module, for example, to add a kit to the tool catalogue and define its contents. Kit specific information may be entered and may include, for example:
Kit Name, Kit Description, Kit Location, Kit Type (default to “Kit”)
Location by Tool Depot
Old Catalogue Number
Indication of Billing Cost with Pre-Load Charge, ICS Rental Rate, Customer Rental Rate and Rental Type

Returning to FIG. 2, step 32 may provide an inventory module that allows for discrete tools, pre-built tool kits, customized tool kits, pieces of equipment and/or consumables to be inventoried. A tool kit may be a collection of discrete items from the tool inventories 17 that are repeatedly used for a particular type of service. Tool kits may be pre-built and available 24 hours a day or they may be custom built in response to a specific tool order. One aspect allows for the inventorying of these or other items to include the assignment of a unique identifier, such as a serial number and/or an SKU for example that may be used to track each item as it moves through various stages of its tool order lifecycle and/or economic useful life. One aspect allows for the “reverse traceability” of any item in the database 20. For example, it is often desirable to determine the discrete uses of a particular tool prior to and after a particular maintenance event involving that tool. This is so the uses of that tool prior to and after the particular maintenance event may be traced if the maintenance event in question resulted in an adverse or abnormal condition. In this respect, an end user may evaluate the “traced” maintenance events prior to and after the maintenance event in question to determine whether the adverse condition resulted from a condition of the tool such as being defective or mis-calibrated, for example, and take corrective action. Each item within database 20 may be assigned a unique identifier, such as an SKU and/or a serial number for example, on creation of database 20, when a newly purchased item is added to database 20 or when a previously purchased item is added. Items that are subject to “reverse traceability” may be assigned a serial number in addition to the SKU. Alternate embodiments allow for certain items in database 20 that are not assigned a unique identifier, i.e., “non-serialized” items. Such non-serialized items may not be subject to “reverse traceability” and may be identified by using a general description of the item.

One aspect allows for the processing and control module to include an ordering module configured for the creation of a tool order in step 34 and for executing other functional tasks such as, for example:
Create and save a “Tool List”—a personal user-defined list of tools that may be groups of tools that are commonly ordered together. When an end user creates a tool order they may retrieve the Tool List instead of ordering each tool individually. In another aspect the Tool List may be a one-time list of tools ordered for a specific job.
Create a Tool Order by using a Tool List or by Browsing the Tool Catalogue
View all Tool Orders by Status
Save or Submit a Tool Order to a Tool Depot
Search for a Tool Order
Assign Tools to the Tool Order (pick/pull)
Create, Edit, View and Inactivate Jobs—a job may contain information specific to the job associated with a tool order such as job name, who placed the tool order, remote site, when items are due on site, start date, estimated finish date, charge numbers, etc.
Search for a Job
Method to Build Kit: Quick Kit if SKU number is known or Browse Catalogue if search is to be conducted by item name
   A tool order may include any item from the tool catalogue such as one or more discrete tools, pre-built tool kits, customized tool kits, pieces of equipment and/or consumables or any combination thereof needed to complete a job. Tool orders may be submitted to one or more tool depots 16 over the Web-based communications medium 22, such as by using a Web-based application running on the Internet, or an Intranet managed by the assignee of the present invention. The ordering module allows for an end user, such as project manager at a remote site 14 for example, to create a tool order by using a conventional computer located at the site to open a Web browser and display a Web page for accessing a tool order form. The tool order form may allow access to the tool catalogue stored in database 20 over a secure Web-based environment. The ordering module may generate a Graphical User Interface display screen configured to display a list of items in the tool catalogue from which the end user may select to include in the tool order. In addition to selecting items from the tool catalogue, the end user may manually enter data specific to the tool order into the Web page.

Step 34 also allows for an end user to build a tool kit. For example, if Quick Kit is selected the end user may enter the SKU number and quantity of the first ten items, for example, in a list of automatically generated text boxes in an interactive Web page to be added to the kit. If Browse Catalogue is selected the end user may enter a search term into the Web page to search the tool catalogue then select that item and its quantity to add it to the kit. Such tool order-specific information may be displayed in dropdown menus and relate to a carrier for shipping the tool order, a name for the tool order, identification of the specific tool depot 16 and remote site 14, and other shipment information such as a scheduled/actual ship date, conveyance type, tracking number, comments, etc. It will be recognized by those skilled in the art that various aspects of the present invention may employ customized display screens and/or Web pages that allow an end user to enter data manually or select options from customized dropdown menus and/or pop-up windows for transmission over the communications medium 22. One aspect allows for the tool order-specific data to be retrieved “off-line” by the end user from pre-loaded tool catalogue databases on a portable PC such as a laptop, for example.

Step 34 allows for a tool order to be created for shipments from at least one of the tool depots 16 to at least one of the remote sites 14 or for return shipments from at least one of the remote sites 14 to at least one of the tool depots 16. One exemplary embodiment allows for one of the tool depots 16 to be the exclusive provider of tools, pre-built tool kits, customized tool kits and/or pieces of equipment to a plurality of remote sites 14. In this respect, groups of remote sites 14, such as power plants, may be concentrated regionally and the owner and/or operator of those sites may choose one localized tool depot 16 to serve those remote sites 14. Alternate embodiments allow for more than one tool depot 16 to serve a group or groups of remote sites 14 as a function of the demands for tools, predefined took kits, customized tool kits and/or pieces of equipment placed on a single tool depot 16 and the regional proximity of another tool depot 16, for example.

One aspect allows for a tool order to be assigned a status for tracking the tool order. A tool order may be assigned a status (tool order status) of, for example:
Saved—a tool order that is saved in a database but that has not been submitted to a tool depot
Submitted—a tool order that has been communicated to a tool depot
Received at Tool Depot—a tool order that has been received by a tool depot
In Process—a tool order that has not been advanced out of the pick/pull process to In Shipping
In Shipping—a tool order that has been moved out of In Process and that may be scheduled to ship or actually shipped

After creating a tool order, step 36 allows for the tool order to be communicated to one or more tool depots 16 such as by transmitting the tool order over the communications medium 22 from a remote site 14, for example, to a tool depot 16. Step 38 allows for each tool order to be processed through the tool order statuses identified above. Providing an end user with immediate access to the status of a tool order allows the end user to plan and schedule service activities at a remote site 14 that depend on the arrival of items in the tool order. Further, step 38 provides an end user with the flexibility to edit a tool order at various stages in the processing of the tool order prior to shipment. For example, in the event of a “forced outage”, or unplanned maintenance event at a remote site 14, a tool depot 16 administrator may put a first tool order on hold so that a second tool order submitted in response to the forced outage may be given priority over the first tool order.

Statuses for jobs may also be assigned using the ordering module, which allows an end user to track activities associated with a job and take action in response to certain events. One aspect allows job statuses to include, for example:
Active—these jobs may be ordered against and billed against
Completed—these jobs can be billed against but not ordered against. This status may be used to prevent additional tool orders being submitted for the job but allow for previous tool orders to be billed.
Finalized—these jobs cannot be ordered against or billed against.

Another aspect of the present invention allows for the ordering module to be configured to interact with other modules described herein in response to certain events associated with the processing of a tool order. For example, the ordering module may interact with the:
Tool catalogue module such that end users may browse the tool catalogue for items to add to their tool list or tool order
Shipping module such that ordered items that are in the pick/pull phase are able to be assigned to shipments
Billing module such that charge number arrangements are specified in the tool order module and acted on by the billing module
Reports module such that certain data related to tool orders may be contained within reports

It will be recognized by those skilled in the art that various modules described herein may interact with other modules to achieve particular results, such as those identified above, and for other results such as generating reports, incrementing/decrementing inventory counts, automatically populating data fields, and automatically generating email and/or other electronic messages, etc. The billing module allows for multiple charge numbers with multiple percentage allocations to be assigned to each tool order or to each line item within the tool order. One aspect of the present invention may provide a shipping module that allows for, in step 40, an end user, such as a tool depot 16 manager, to create a shipment or tool shipment in response to receipt of a tool order at the depot. The shipment or tool shipment may be an electronic shipment document containing data relating to shipping a set of items from a tool depot 16 to one or more remote sites 14. To create a new shipment, an end user may enter data into interactive screens displayed in a Web Browser indicative of the ship from and ship to locations, a carrier and contact information if necessary. The shipment module may interact with the ordering module so that an end user may select specific orders from a dropdown menu to be included in a shipment. Shipment contents may be added to the shipment by selecting items from the tool catalogue listed in a dropdown menu. A bill of lading and packing list may be created and printed when the shipment content and associated information have been confirmed. If the shipment is shipping immediately the end user may click on an icon to automatically update the shipments status. The shipping module allows for an end user to assign tool orders to shipments between one or more tool depots 16 and one or more remote sites 14, or from sites to depots.

One aspect of step 40 allows for a default shipment to be automatically created by the shipping module for each tool order that is received by a tool depot 16. The default shipment may represent the shipment that contains all items selected in a received tool order and is advantageous in that without the automatic creation of a default shipment an end user would need to manually assign all items in a tool order to a shipment, which would be very time consuming for large tool orders. The default shipment is then in the queue to be assigned a shipping date. Each item selected in a tool order needs to be “picked” at a tool depot 16 and “pulled” for preparation to be shipped to a remote site 14. As each item is “pick/pull”, the shipping module allows for the item to be automatically added to or associated with the default shipment. It is contemplated that some tool orders may require multiple shipments that originate from multiple tool depots 16 to supply a single remote site 14 with the necessary tooling for fulfilling the tool order. One aspect allows for a default shipment to be combined with another default shipment to maximize the size of a shipment and minimize the overall cost of shipping selected items. In this respect, one shipment may contain items being shipped to more than one remote site 14, for example.

Step 42 allows for the inventory module to track various attributes of tools as well as the workflow of filling a tool order, for example, and allows for an administrator to manually adjust the quantity, status and/or condition of items, particularly specific tools, in the tool catalogue. Part of the tracking of a tool order may include the packing of a set of tools ordered in the tool order. One aspect allows for a first subset of the set of tools to be packaged in response to the tool order with subsequent subsets to followdepending on the availability and time demands for the tool, for example. In this respect, the set of ordered tools may be packaged and shipped in multiple shipments from a single tool depot 16 to a remote site 14 or the first subset may originate from one tool depot 16 and subsequent subsets from other tool depots 16. Step 42 allows for each tool within the set of ordered tools to be tracked as it moves through a sequence of events before, during and after being used for the performance of services at a remote site 14. The inventory module may provide for the overall management and tracking of serialized tools, non-serialized tools and serialized tool kits as well as the specific tool contents within a tool kit. For example, the inventory module may be configured to create records in database 20, for example, containing data indicative of attributes or information specific to each item in the tool catalogue. The inventory module may also include modules that allow an end user to execute tasks related to the tool catalogue. These functional modules, as well as other modules disclosed herein, may be accessed by an end user employing a Web browser, Web screens, navigation bars, task bars and/or drop down menus as will be recognized by those skilled in the art. For example, the inventory module may be used to perform, for example:
View/Edit Status and Condition
View/Edit Inspection Record
View Tracking Log
Refurbish/Disassemble Kit
   The information specific to each item in the tool catalogue may include but is not limited to a serial number, an SKU, a status of the item, a condition of the item, a location of the item, a quantity of the item and a date the item was entered into the tool catalogue database 20, for example. Examples of the status information pertaining to an item may include, for example:
Available—able to be assigned the item to a tool order
In Kit [kit serial number]—an item is physically located in a tool kit and may be available to be assigned to a tool order depending on the status of the tool kit
Picked—an item is assigned to a tool order but not yet shipped and not able to be assigned to another tool order unless it is unpicked first
At Inspection—an item is not able to be assigned to a tool order and is currently being inspected and/or calibrated
On Site—an item is not able to be assigned to a tool order unless the item is no longer needed for service at the site and the inventory module determines that the item may be shipped to another site in response to a tool order
On Order—an item's status is incremented to Available when the item is received at a tool depot via a purchase order
Unavailable—for tool kits that have been inventoried and assessed but not refurbished
Removed from Inventory—an item is not able to be assigned to a tool order Examples of the status information pertaining to a specific tool kit may vary slightly from the statuses of other items because specific tool kits may contain a extensive array of individual tools, other tool kits and/or other maintenance equipment and may include, for example:
Available
On Site
Unavailable
   Examples of the condition information pertaining to an item may include, for example:
Ok
Worn
Broken
Lost
Stolen
   The inventory module may also track and store historical information pertaining to an item to establish minimum and maximum inventory levels as a function of demand placed on that item. It may also automatically generate a re-order report in a purchasing module whenever an item falls below a minimum level and the tool is assigned the status of active, for example. Alternate aspects allow for a re-order report to be generated in response to other predefined criteria. The inventory module may also track items by their respective condition, such as broken or stolen for example, and automatically generate a report on tool losses and damages on a near real time basis. Another aspect of the inventory module allows for the tracking the number of times an item, such as a tool kit, cycles between a tool depot 16 and a remote site 14 in a given period time. This aspect allows for more accurate predictions of tool kit usage and asset management. Another aspect allows for the inventory module to refurbish (build) or disassemble (un-build) a tool kit. In this respect, on receipt of a tool order at a tool depot 16, the inventory module may automatically increment or decrement the respective record in the tool catalogue database 20 as a tool is added to the tool kit from the respective depot's physical inventory or when a tool is removed from the tool kit and returned to that depot's physical inventory.

The inventory module may also be configured to track, store, in database 20 for example, and retrieve historical data associated with any single item in the tool catalogue. For example, historical data such as purchase information, associated tool kit history and/or job/site usage may be stored for later statistical analysis. One advantage of this aspect is that the inventory module may be used for capital asset tracking and management by linking an item, such as a serialized tool, with the original purchase order. This type of linking allows for item-specific information to be tracked and analyzed over time such as, for example:
E-Number or Capital Asset Tag
Tool Name and Description
Price/Cost of Item
Tool Unit Number
Serial Number
Appropriation Number
Purchase Order Number and Date
Disposition Date
Projected Date of Retirement
   Another advantageous aspect of the inventory module is the ability to track the periodic inspection and/or calibration due dates for those items in the tool catalogue requiring such action. The inventory module may generate a notification indicating that an item has an inspection/calibration due date pending so that personnel may take appropriate action. The inventory module may automatically update the record in database 20 associated with an item to indicate the item's next inspection date and/or returned from inspection date and other information specific to that item such as the location of the inspection and/or calibration station, for example, which may be identified in the tool catalogue. Other associated data may be contained within a respective record, such as comments or unique identifiers for example, as a function of end user requirements.

Step 44 allows for the items selected for a tool order to be shipped to the remote site 14. It is contemplated that items may be shipped by any appropriate means such as via truck, air and/or rail, for example. Multiple shipments may be needed for a tool order. One aspect of the present invention allows for an end user to view the tool catalogue at the remote site 14 and select an item from the tool catalogue and the specific tool depot 16 from which the selected item will be shipped. In this respect, each tool depot 16 may store a quantity of common items and each tool depot 16 may store specialized items that are not found at another tool depot 16. The inventory module may associate each item in the tool catalogue with its location or locations so that the end user will select both the item and the originating tool depot 16. Another aspect allows for the order module to be configured to automatically select which tool depot 16 will be the source for an item ordered by the end user. This aspect allows the order module to select the source of an item rather than the end user as a function of predetermined criteria such as tool availability, shipping costs, critical delivery dates, etc. The inventory module may also allow for an end user to indicate that a “forced outage” has occurred at a remote site 14. In this case the inventory module may flag the occurrence of the forced outage and assign priority to the respective end user's tool order to ensure that the items needed to service the forced outage are given priority over tool orders for scheduled maintenance services that request the same items. When necessary items from the inventory of tools 17 arrive at a remote site 14 then step 46 allows for the necessary maintenance services to be performed.

Returning to step 42, items from the tool catalogue may be tracked after they have arrived at a remote site 14. For example, a millwright, or the individual responsible for managing a tool room at the remote site 14, may use a handheld pocket PC having barcode capability to facilitate the tracking of items. When a shipment of items arrives at a site some of the items, such as non-serialized tools for example, may be temporarily stored in bins or on shelves located within the tool room at the site 14. Each bin and/or shelf may include a barcode affixed thereto and/or a bumpy barcode that may be engraved or otherwise etched into the bin or shelf. The millwright may use the handheld pocket PC to scan the barcode associated with a bin or shelf when removing an item from the bin or shelf, entering data indicative of the item into the handheld PC and assigning the item to a specific maintenance personnel at the site 14. The millwright may also scan a barcode imprinted on the maintenance personnel's identification badge to associate the assigned item with the specific maintenance personnel. This aspect allows for precise tracking of each item at the remote site 14 and for holding the specific maintenance personnel accountable for the item assigned to that individual. This aspect is advantageous in that it allows for a detailed tracking of each item while at the site 14 and helps to prevent theft of and damage to items, which may prove to be a significant cost savings for the financial stakeholder providing maintenance services at the remote sites 14. When the item is returned, the millwright may scan the personnel's badge and barcode to indicate the item has been returned. Data from the handheld PC may then be transferred to the inventory module indicating the status and other attributes of that item.

Other aspects of the present invention allow for barcodes generated by the control module, for example, to be placed directly on certain items, such as serialized tools and/or tool kits for example, so that the barcodes may be scanned to help track these items as they move through a tool order lifecycle. Each barcode and/or bumpy barcode may contain data indicative of information specific to an item such as the barcode indicia itself, the associated tool depot's 16 name, the item's name, an SKU and a serial number, for example. Data collected from barcodes may be transferred to various computing modules described herein to update associated records with information pertaining to an item as it moves through the tool order lifecycle. The handheld pocket PC units may be used to scan a barcode associated with a new purchase item when it arrives at a tool depot 16 to enter that item into the inventory of tools 17. The handheld units and barcodes may be used with other aspects of the present invention such as being used by tool depots 16 during the “pick/pull” process when filling a tool order and returning and assessing the condition of items being returned to inventory from a remote site 14, for example.

On completion of all or a portion of the services at a site 14, in one embodiment step 48 allows for some or all of the items used for performing those services to be prepared for shipment back to the originating tool depot 16. Multiple shipments may be needed to return all items back to the originating tool depot 16. One aspect allows for the inventory module to be configured to automatically determine whether an item or items should be returned to their respective originating tool depot 16 or be prepared for shipment to another location such as another remote site 14 or a regional transfer depot (not shown), for example. Regional transfer depots may be situation at various locations to serve one or more of the tool depots 16 and remote sites 14. This determination may be made by a range of factors and at least in part by the demand on a specific item, as reflected in a tool order from another site 14, and that particular item's location, calibration and inspection due dates and status when the tool order is submitted for processing, etc. Another aspect allows for an end user at a site 14 to determine the shipment destination of an item. Once prepared for shipping, step 50 allows for creating a shipment of the items from the site to their respective destinations such as an originating tool depot 16. In this respect, tool depot 16 personnel may use the shipping module to create a site-to-depot shipment for returning or shipping items from a remote site 14 to a tool depot 16 on completion of services performed at a remote site 14.

One aspect of the present invention allows for, in step 52, the billing module to automatically prepare and generate a rental invoice for items used at a remote site 14 for each maintenance event and/or billing for any items associated with a tool order that are lost, damaged or stolen, for example. Rental rates and replacement costs for items may be stored in database 20, for example, as part of the tool catalogue. The billing module may automatically retrieve these costs as needed from database 20 and automatically populate a rental invoice and/or a billing invoice for lost, damaged or stolen items with the appropriate costs. The billing module may allow for adjustments to be made to the invoices such as adding miscellaneous rental charges and/or miscellaneous other charges such as freight, for example. A rental charge may be automatically initiated when an item is shipped from a tool depot 16 on route to a remote site 14 and automatically stopped when the item is received at the tool depot 16 after performance of services at the remote site 14. In this respect, the billing cycle may be automatically initiated in response to the shipping module when the associated item is shipped from the tool depot 16 to the remote site 14 and automatically stopped when received in a return shipment. Alternate embodiments allow for the billing cycle to start and stop as a function of other events associated with the processing of a tool order. One aspect allows for the shipping module to be interoperable with the billing module and configured for automatically generating an invoice reflecting the completion of a billing cycle or cycles. The invoice may then be communicated to the end user, for example, over the Web-based communications medium 22.

When items are returned from a remote site 14 to the originating tool depot 16, step 54 allows for those returned items to be inventoried. For example, the inventory module may allow for, in step 54, counting the number of items returned from a remote facility 14, such as a power plant, and entering the actual returned quantity into database 20, for example. The inventory module may generate an interactive screen within an end user's Web browser that may provide a listing of all item shipments being returned to a tool depot 16 so that the end user may select a specific shipment of interest. On selection of a specific shipment, all items within that shipment may appear in the screen for the end user's review and may be organized by tool kits, serialized tools, non-serialized tools, etc. All items returned to a tool depot 16 via a remote site 14 to tool depot 16 shipment may be assessed in step 56. An assessment may assign a condition to each item returned. As noted above, conditions may include 1) Ok (serviceable)—can be assigned to a tool order; 2) Worn; 3) Broken; 4) Lost or 5) Stolen. An end user may enter data indicative of an item's condition manually and/or via a handheld PC and the inventory module may update all records in database 20 associated with the condition of that item. Similarly, step 58 allows for an item's status to be manually entered into the inventory module on return from a remote site 14 such as those noted above, or the inventory module may automatically update an item's status in response to data entered into other modules described herein such as by incrementing the quantity of an item in response to the purchasing module, for example. The inventory module may automatically update all records associated with the status of that item.

One aspect of the present invention allows for, in step 60, a purchase order module to be used to create a purchase order for the purchase of new items for replacing or increasing the quantity available of existing items in the inventory of tools 17 or for adding new items to that inventory. The purchase module may be configured to create and track purchase orders and to arrange for the purchased items to be drop-shipped at a remote site 14 or shipped to a tool depot 16, for example. An end user may enter item specific information, such as DepoVSite Name, Job Name and Order Name (if drop-shipping to a site), Supplier, Purchase Order Date, Estimated Delivery Date, Shipping Method and Purchaser/Buyer for example, into the purchasing module to initiate the creation and submission of a purchase order. Other information may be entered into the purchase module to further identify the item being purchased such as the SKU, Quantity, Unit of Measure, Description, Manufacturer Name, Part Number and Unit Price, for example. The purchasing module may interact with other modules described herein such as the tool catalogue module, the shipping module and the inventory module. For example, once a purchase order is transmitted for processing the inventory module will be automatically updated. A purchase order may be transmitted to the control module, for example, for processing and manual delivery to a vendor. In addition, or alternatively, a purchase order may be transmitted directly to a vendor via the communications medium 10. In this respect, for non-serial items the quantity “on-order” will be incremented in the inventory module by the quantity ordered on the purchase order and if a serial tool is ordered, new serial numbers will be pre-assigned in the inventory module with a status of “on-order”. One aspect allows for a purchase order shipment to be created when a purchase order is submitted. This shipment may be used to track the receipt of ordered items at the tool depot 16 or those drop-shipped to a remote site 14. Once the shipment is marked as received by a tool depot 16 in the shipment module, the status of each item may be marked as “Available” in the inventory module. When a tool order is marked as received by a site via a drop-shipment, the inventory module may increment the job assigned quantity by the quantity ordered in the purchase order.

Another aspect of the present invention allows for the shipping module, in step 62, to be used for editing, deleting or advancing shipments at various stages in the shipping process. The shipping module may be used to create shipments in steps 40 and 50. In addition to creating shipments the shipping module may allow for searching for existing shipments. Searching may be based on different types of shipment searches. One aspect allows for searching for the following types of shipments:
Scheduled to Ship
Shipped
Pending Arrival at Tool Depot
Arrived at Tool Depot
   An end user may search for these types of shipments and, in step 64, view shipment details. For example, summary and detailed information for each shipment may be displayed for review by the end user to determine a status of the shipment, edit details, delete details and/or confirm the status of the shipment to advance it for continued processing. One aspect of the shipping module interacting with the billing module allows for the creation of a bill of lading and/or a packing list for shipping items internationally such as to Canada or Mexico, for example. In this respect, when a tool order is shipped internationally certain items in the order may need to be assigned international shipping codes or numbers. For example, a Schedule B Number (10-digit government export code), an Export Control Classification Number and/or a Harmonized Tariff Code may need to be assigned to internationally shipped items from the tool catalogue. Information regarding Material Safety Data Sheets and Hazardous material may also be associated with relevant items. The tool catalogue may be associated with a database containing these respective codes, numbers and other information for each item needing one or more of them so that when an end user selects an item from the tool catalogue the associated codes, numbers and information will automatically be populated in the respective bill of lading and/or packing list.

Another aspect of steps 62 and 64 is that they allow for an end user to search for, view, edit, delete and/or advance shipments relating to the purchase of items via a purchase order or other purchasing agreement. The shipping module may allow an end user to search for existing purchase shipments based on different types of shipment searches. One aspect allows for searching for the following types of shipments:
Pending Arrival at Tool Depot
Arrived at Tool Depot
Pending Drop Shipment to Site
Drop Shipped to Site
   Summary and detailed information for each purchase shipment may be displayed for review by the end user to determine a status of the shipment. An end user may enter data into an interactive screen displayed in a Web browser indicative of events associated with each purchase shipment. For example, an end user may enter the actual quantity received of a purchased item and compare that to the quantity ordered listed on the display screen. Any discrepancies may then be resolved. The shipping module may interact with the inventory module to automatically update database 20 with information associated with the purchase of a new item such as incrementing the quantity of a respective item available in the tool catalogue. An end user may click on an icon in the display screen to print a list of barcodes associated with the items in any shipment, such as with a packing list for example. The barcodes may then be used for tracking the items during the tool order cycle by scanning the barcodes associated with the packing list rather than having to scan barcodes affixed to each individual item.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A method in a data processing system of tracking tools in a power plant service environment where a plurality of power plant facilities are interconnected in a Web-based environment over a communications medium with a tool depot wherein the tool depot houses a tool inventory used for providing a plurality of service activities to the plurality of power plant facilities, the method comprising:
providing a database containing information associated with respective tools in the tool inventory;
including in the database information uniquely associated with at least a first tool in the tool inventory;
assigning the first tool to a person at a power plant facility; and
recording data in the database that associates the person with the first tool.

2. The method of claim 1 further comprising:
updating the database with at least a portion of the recorded data sufficient to associate the person with the first tool.

3. The method of claim 1 further comprising:
creating an electronic tool order document containing information associated with at least the first tool wherein the tool order document is transmitted over the communications medium from the power plant facility to the tool depot.

4. The method of claim 3 further comprising:
creating an electronic default shipment document containing information relating to shipping at least the first tool from the tool depot to the power plant facility wherein the electronic default shipment document is automatically populated with at least a portion of the information transmitted to the tool depot in the electronic tool order document.

5. The method of claim 3 further comprising:
creating an electronic shipment document containing information relating to shipping at least the first tool from the tool depot to the power plant facility wherein the electronic shipment document is automatically populated with at least a portion of the information transmitted to the tool depot in the electronic tool order document.

6. The method of claim 3, the step of creating the electronic tool order document comprising:
populating at least a portion of an electronic tool order form displayed in an interactive Web page with information relating to at least one of the power plant facility and the tool depot and the first tool;
accessing the database over the communications medium from the power plant facility; and
selecting at least the first tool via an interactive Web page from at least one of a predefined tool list displayed in the Web page and a browse function displayed in the Web page wherein the browse function is configured to search the database and display information contained in the database associated with respective tools in the tool inventory.

7. The method of claim 3 further comprising:
updating the database in response to filling the tool order wherein a quantity of respective tools contained in the database is decremented by a quantity of the respective tools shipped to the power plant facility.

8. The method of claim 3 further comprising:
checking the database in response to receipt of the electronic tool order document at the tool depot to determine a status of at least one tool contained within the tool order document; and
creating a purchase order document for a tool in the event the step of checking identifies the status of the tool as unavailable.

9. The method of claim 3 further comprising:
including in the database information describing a status in response to receipt of the electronic tool order document wherein the status is indicative of tracking at least the location of tools identified in the electronic tool order document between the tool depot and the remote facility.

10. The method of claim 3 further comprising:
updating the database in response to filling the tool order wherein a quantity of respective tools contained in the database is decremented by a quantity of the respective tools shipped to the power plant facility;
including in the database information describing a condition of at least one tool prior to the at least one tool being shipped to the power plant facility;
assessing the condition of the at least one tool received at the tool depot from the remote facility;
updating the database in the event the step of assessing determines that the condition of the at least one tool has changed;
generating an invoice reflecting the cost of using the shipped tools at the remote facility; and
transmitting the invoice over the communications medium from the tool depot to the remote facility.

11. The method of claim 1 further comprising:
including in the database information describing a condition of at least one tool in the tool inventory;
including in the database information describing a status of at least one tool in the tool inventory;
receiving at least a tool at the tool depot wherein the tool is being returned to the tool depot from the power plant facility;
assessing the condition of the tool; and
updating the database with information describing the condition of the tool in the event the step of assessing determines that the condition of the tool has changed.

12. The method of claim 1 further comprising:
creating an electronic tool order document containing information associated with at least the first tool wherein the electronic tool order document is transmitted over the communications medium from the power plant facility to the tool depot;
creating an electronic shipment document containing information relating to shipping at least the first tool from the tool depot to the power plant facility wherein the electronic shipment document is automatically populated with at least a portion of the information transmitted to the tool depot in the electronic tool order document;
creating a return electronic shipment document containing information relating to shipping at least the first tool from the tool depot to the power plant facility wherein the electronic shipment document is automatically populated with at least a portion of the information transmitted to the tool depot in the electronic tool order document;
including in the database information describing a condition of at least the first tool prior to the first tool being shipped to the power plant facility;
assessing the condition of at least the first tool after its return to the tool depot;
updating the database in the event the step of assessing determines that the condition of the at least one tool has changed; and
updating the database with information indicating that the first tool is no longer assigned to the person at the power plant facility.

13. A method of managing and tracking tools used in a power plant service environment wherein multiple power plants require services that necessitate the multiple utilization of an inventory of the tools stored in at least one tool depot, the method comprising:
providing a database containing information describing the inventory of tools;
providing access to the database to respective end users at each of the multiple power plants via a communications medium;
communicating over the communications medium an order for a set of tools to a tool depot; and
populating a shipping document with information relating to shipping the set of tools from the tool depot to a power plant.

14. The method of claim 13 further comprising:
accessing the database from the power plant so that an end user at the power plant may search the database via an interactive Web page for selecting at least one tool in the set of tools; and
selecting the at least one tool via the interactive Web page to create the order.

15. The method of claim 14 further comprising:
automatically updating the database with information changing a status of the at least one selected tool.

16. The method of claim 13 further comprising:
creating an electronic purchase order document for the purchase of at least one tool.

17. The method of claim 16 wherein the electronic purchase order document is created in response to the order for the set of tools in the event at least one of the tools ordered is not available from the inventory of tools.

18. The method of claim 16 further comprising:
receiving the at least one purchased tool at a tool depot; and
updating the database with information indicative of a quantity of the received tool.

19. The method of claim 18 further comprising:
updating the database with information indicative of at least one of a status and a condition of the purchased tool.

20. The method of claim 16 further comprising:
receiving notice at a tool depot that the at least one purchased tool has been shipped by a vendor wherein the at least one purchased tool will be drop-shipped to a power plant;
initiating a billing cycle for charging a cost to the power plant for use of the at least one purchased tool; and
updating the database with information indicative of changing a status of the at least one purchased tool from on-order to job-assigned.

21. The method of claim 13 further comprising:
updating the database with information indicative of at least one tool of the set of tools having been shipped to the power plant;
initiating a billing cycle for charging a cost to the power plant for use of the shipped tool; and
stopping the billing cycle associated with the shipped tool on receipt of the shipped tool at the tool depot.

22. The method of claim 13 further comprising:
defining at least one tool kit comprising at least a subset of the inventory of tools;
storing data in the database indicative of information describing the at least one tool kit; and
communicating an order for the at least one tool kit over the communications medium to a tool depot.

23. The method of claim 13 further comprising:
creating a bill of lading containing data indicative of at least one of a Schedule B Number and an Export Control Classification Number and a Harmonized Tariff Schedule in response to the tool order.

24. The method of claim 13 further comprising:
including in the database information uniquely associated with at least a first tool in the inventory of tools wherein the order for the set of tools includes the first tool;
checking out the first tool to a person at the power plant;
recording data at the power plant that associates the person with the first tool;
transmitting over the communications medium at least a portion of the data entered in the step of entering; and
automatically updating the database with at least a portion of the transmitted data sufficient to associate the person with the first tool.

25. A method of managing tools in a field service environment wherein a plurality of service activities are performed at a plurality of job sites with a plurality of tools, the method comprising:
using a first tool of the plurality of tools to perform a plurality of sequential service activities;
storing in a database information uniquely associating the first tool with the performance of the sequential service activities; and
accessing the database to reverse trace information regarding the use of the first tool for performing the sequential service activities.

26. The method of claim 25 further comprising:
storing in the database information uniquely associated with a plurality of tool users; and
updating the database with information identifying at least one tool user for each use of the first tool for performing the sequential service activities.

27. The method of claim 25 further comprising:
determining whether the use of the first tool for performing the sequential service activities resulted in an abnormal condition associated with at least one of the sequential service activities.

28. The method of claim 27 further comprising:
assessing a condition of the first tool in the event the step of determining results in at least one abnormal condition.

29. The method of claim 28 further comprising:
determining whether the at least one abnormal condition resulted from the condition of the first tool; and
performing a service activity to correct the at least one abnormal condition.

30. The method of claim 25 further comprising:
communicating an order for the first tool over a communications medium to a tool depot housing a tool inventory wherein the first tool is ordered for performing at least one of the plurality of sequential service activities;
creating a shipping document containing information relating to shipping the first tool from the tool depot to a first job site; and
automatically decrementing a quantity of the first tool contained in the database.

31. The method of claim 30 further comprising:
assigning the first tool to a person at the first job site; and
recording data at the first job site associating the person with the first tool.

32. The method of claim 25 further comprising:
including in the database a calibration due date for the first tool;
including in the database an inspection due date for the first tool;
determining whether the first tool needs to have at least one of a calibration service and an inspection service performed prior to being used for the next sequential service activity; and
providing notice if in the step of determining the first tool needs to have at least one of a calibration service and an inspection service performed prior to being used for the next sequential service activity.

33. The method of claim 25 wherein the first tool is shipped between at least two of the plurality of job sites prior to being returned to a tool depot.
